(19) United States
(12) Patent Application Publication
(10) Pub. No.: US 2010/0201481 A1
(43) Pub. Date: Aug. 12, 2010

(54) Security System, Modules and Method of Operation Thereof

(76) Inventors: Jonson Chung-shun Au, Milpitas, CA (US); Melvin Sik Yu Li, Milpitas, CA (US)

Correspondence Address: Melvin S. Li, 548 Market Street, Suite #33410, San Francisco, CA, 94104, US

(21) Appl. No.: 12/367,554

(22) Filed: Feb. 9, 2009

(51) Int. Cl. G05B 19/00

(52) U.S. Cl. 340/5.51; 340/5.7; 340/5.72

(57) ABSTRACT

The present invention provides a security system comprising (a) at least a first handheld device, a first secure entity and a second secure entity, wherein the first handheld device and the first secure entity are programmable to enter into a first unique communication mode in which only the pair of the first handheld device and the first secure can respond to each other's instructions and wherein the first handheld device and the second secure entity are programmable to enter into a second unique communication mode in which only the pair of the first handheld device and the second secure entity can respond to each other's instructions, or (b) at least a first handheld device, a second handheld device and a first secure entity, wherein the first handheld device and the first secure entity are programmable to enter into a first unique communication mode in which only the pair of the first handheld device and the first secure can respond to each other's instructions and wherein the second handheld device and the first secure entity are programmable to enter into a second unique communication mode in which only the pair of the second handheld device and the first secure entity can respond to each other's instructions.

### FIELD OF THE PRESENT INVENTION

The present invention is concerned with a security system for controlling access to one or more secure entities by one or more users. The present invention is also concerned with, but not limited to, modules of such security system, a method of providing such security system, a method of operating or implementing such security system and a platform of allowing different modules being compatible with each other in such security system.

### BACKGROUND OF THE PRESENT INVENTION

Mechanical locks and keys have been used for thousands of years for controlling access to premises. Nowadays, it is still typical that a user would require two mechanical keys to gain access to his/her residence. One of the mechanical keys may be for the knob-type lock on the main door to the residence and the other mechanical key may be for the deadbolt lock for added security. Then the user may have a further mechanical key for his/her primary car and a further electronic remote alarm device for the car. If the user has a second car or has access to the spouse's car, s/he may have two more electronic handheld devices to carry with the key chain. In addition, s/he may have one or two more mechanical or electronic keys or card keys for access to his/her work place. As can be realized, the user can easily be carrying about ten keys of different types. This is very cumbersome.

The present invention seeks to provide a solution to the above described problem, or at least to provide an alternative to the general public.

### SUMMARY OF THE INVENTION

According to a first aspect of the present invention, there is provided a security system, comprising (a) a first handheld device configured to emit a first wireless signal encoding a first instruction, and (b) a first secure entity configured to receive the first wireless signal and, on receiving the first wireless signal, carry out the first instruction to perform a first predetermined action corresponding to the first instruction and then send out a second wireless signal corresponding to the first predetermined action providing an indication of the performance of the first predetermined action via the first handheld device, wherein the first predetermined action is selected from a group including (i) locking or unlocking the first secure entity, (ii) arming or disarming the first secure entity, (iii) allowing or disallowing access to the first secure entity, (iv) activating or deactivating the first secure entity or (v) checking locked/unlocked status of the first secure entity, wherein the first wireless signal is irrespondable by secure entities not having previously registered with the first handheld device, and wherein the second wireless signal is irrespondable by handheld devices not having previously registered with the first secure entity. The secure entity

In one embodiment, the first handheld device may be configured to emit a third wireless signal encoding a second instruction for reception by the first secure entity, wherein the first secure entity is configured to, on receiving the third wireless signal, carry out the second instruction to perform a second predetermined action corresponding to the second instruction and send out a fourth wireless signal corresponding to the second predetermined action providing an indication of the performance of the second predetermined action via the first handheld device, wherein the second predetermined action is different from the first predetermined action and is selected from a group including (i) locking or unlocking the first secure entity, (ii) arming or disarming the first secure entity, (iii) allowing or disallowing access to the first secure entity, (iv) activating or deactivating the first secure entity or (v) checking locked/unlocked status of the first secure entity.

In another embodiment, the security system may comprise a second secure entity with which the first handheld device previously registered each other, wherein the first handheld device is configured to emit a fifth wireless signal encoding a third instruction for reception by the second secure entity, wherein the second secure entity, is configured to, on receiving the fifth wireless signal, carry out the third instruction to perform a third predetermined action corresponding to the third instruction and send out a sixth wireless signal to the second secure entity corresponding to the third predetermined action providing an indication of the performance of the third predetermined action via the second secure entity, wherein the third predetermined action is selected from a group including (i) locking or unlocking the second secure entity, (ii) arming or disarming the second secure entity, (iii) allowing or disallowing access to the second secure entity, (iv) activating or deactivating the second secure entity or (v) checking locked/unlocked status of the first secure entity.

In yet another embodiment, the security system may comprise a second handheld device with which the first secure entity previously registered each other, wherein the second handheld device is configured to emit a seventh wireless signal for reception by the first secure entity, wherein the first secure entity is configured to, on receiving the seventh wireless signal, carry out a fourth instruction to perform a fourth predetermined action corresponding to the fourth instruction and send out an eighth wireless signal to the first secure entity corresponding to the fourth predetermined action providing an indication of the performance of the fourth predetermined action via the second handheld device, wherein the fourth predetermined action is selected from a group including (i) locking or unlocking the first secure entity, (ii) arming or disarming the first secure entity, (iii) allowing or disallowing access to the first secure entity, (iv) activating or deactivating the first secure entity or (v) checking locked/unlocked status of the first secure entity. Alternatively, the security system may comprise a second handheld device with which the second secure entity previously registered, the second handheld device is configured to emit a ninth wireless signal for reception by the second secure entity, wherein the second secure entity is configured to, on receiving the ninth wireless signal, carry out a fifth instruction to perform a fifth predetermined action corresponding to the fifth instruction and send out a tenth wireless signal to the second secure entity corresponding to the fifth predetermined action providing an indication of the performance of the fifth predetermined action via the second handheld device, wherein the fifth predetermined action is selected from a group including (i) locking or unlocking the second secure entity, (ii) arming or disarming the second secure entity, (iii) allowing or disallowing access to the second secure entity, (iv) activating or deactivating the second secure entity or (v) checking locked/unlocked status of the second secure entity.

Advantageously, one or more further secure device(s) may be registrable with the first handheld device and/or one or more further handheld devices may be registrable with the first secure entity, for communicating therewith one or more further predetermined action(s).

In another embodiment, the secure entity may be configured to emit a further wireless signal when a predetermined status is detected by the secure entity, wherein the security system may be configured such that only the first handheld device is respondable to the further wireless signal, leading to a corresponding indication on the first handheld device.

According to a second aspect of the present invention, there is provided a security system comprising (a) at least a first handheld device, a first secure entity and a second secure entity, wherein the first handheld device and the first secure entity are programmable to enter into a first unique communication mode in which only the pair of the first handheld device and the first secure entity can respond to each other's instructions and wherein the first handheld device and the second secure entity are programmable to enter into a second unique communication mode in which only the pair of the first handheld device and the second secure entity can respond to each other's instructions or (b) at least a first handheld device, a second handheld device and a first secure entity, wherein the first handheld device and the first secure entity are programmable to enter into a first unique communication mode in which only the pair of the first handheld device and the first secure can respond to each other's instructions and wherein the second handheld device and the first secure entity are programmable to enter into a second unique communication mode in which only the pair of the second handheld device and the first secure entity can respond to each other's instructions.

The handheld device may, for example, be a car key, a car alarm remote control or a cellular phone for controlling access to a secure entity. In one embodiment, the handheld device may comprise means for a user to input command for emitting the wireless signal. The input means may be one or more physical and/or virtual touch-screen keys or buttons. The handheld device may also comprise means for displaying the indication to a user.

According to a third aspect of the present invention, there is provided a handheld device in a security system, comprising (a) means for allowing the handheld device be registrable with a first secure entity, (b) means for emitting a first wireless signal encoding a first instruction for response by only the first secure entity instructing the first secure entity to perform a first predetermined action, (c) means for receiving a second wireless signal emitted from the first secure entity providing a first indication of the performance of the first predetermined action or reporting status of condition of the first secure entity, (d) means for displaying the first indication on the handheld device, (e) means for allowing the handheld device be registrable with a second secure entity, (f) means for emitting a third wireless signal encoding a second instruction for reception by the second secure entity instructing the second secure entity to perform a second predetermined action, (g) means for receiving a fourth wireless signal emitted from the second secure entity providing a second indication of the performance of the second predetermined action or reporting status of condition of the second secure entity and (h) means for displaying the second indication on the first handheld device, wherein the signals are configured to be irrespondable by secure entities not previously registered with the first handheld.

According to a fourth aspect of the present invention, there is provided a secure system, comprising (a) means for allowing the security entity be registrable with a first handheld device, (b) means for receiving a first wireless signal encoding a first instruction from the first handheld device, (c) means for performing a first predetermined action corresponding to the first instruction, (d) means for emitting a second wireless signal respondable by only the first handheld device providing an indication of the performance of the first predetermined action or reporting status of condition of the secure entity, (e) means for allowing the secure entity and a second handheld device be registrable with each other, (f) means for receiving a third wireless signal encoding a second instruction from the second handheld device, (g) means for performing a second predetermined action corresponding to the second instruction, and (h) means for emitting a fourth wireless signal respondable by the second handheld device providing an indication of the performance of the second predetermined action or reporting status of condition of the secure entity.

The secure entity may for example be a conventional vehicle, premises or computer with which control of access thereto is required although with respect to this present invention it is provided with a base unit such that the access control is achievable.

In one embodiment, the secure entity may be configured to emit a fifth wireless signal when a predetermined status is detected thereby, wherein the fifth wireless signal is respondable by the first and/or second handheld device, leading to an indication on the first and/or second handheld device(s) and advising user of the first and/or second handheld device(s) of the predetermined status.

Preferably, the wireless signals may be of radio frequency signals.

According to a fifth aspect of the present invention, there is provided a method of unique communication between a handheld device as described in the above mentioned third aspect of the present invention and a secure entity as described in the above mentioned fourth aspect of the present invention in a security system.

### BRIEF DESCRIPTION OF THE DRAWING

The present invention will be explained by ways of non-limiting examples, with reference to the attached drawings, in which:

FIG. 1 is a schematic diagram showing different modules and their relationship in an embodiment of a security system in accordance with the present invention;

FIG. 2 is a schematic diagram showing different modules and their relationship in another embodiment of a security system in accordance with the present invention;

FIG. 3 corresponds to FIG. 2 but with more information showing the working of the different modules;

FIG. 4 is a schematic diagram showing the working of unique communication of a module pair of FIG. 2;

FIG. 5 is a schematic diagram showing the working of unique communication of another module pair of FIG. 2;

FIG. 6 is a schematic diagram showing the working of unique communication of yet another module pair of FIG. 2;

FIG. 7 is a schematic diagram showing different modules and their relationship in another embodiment of a security system in accordance with the present invention;

FIG. 8 is a schematic diagram showing another embodiment of a security system in accordance with the present invention;

FIG. 9 is a schematic diagram showing the appearance of an embodiment of a handheld device in accordance with an embodiment of the present invention.

### DETAILED DESCRIPTION OF PREFERRED EMBODIMENTS OF THE PRESENT INVENTION

The present invention seeks to provide a solution which allows a (or “each”) user to carry only one handheld device, and with which, the user will not need to carry multiple devices for gaining access to multiple secure entities or premises. The secure entity may be a vehicle, premises such as a residence or an office, or a computer, control of access thereto is required.

### Embodiment 1

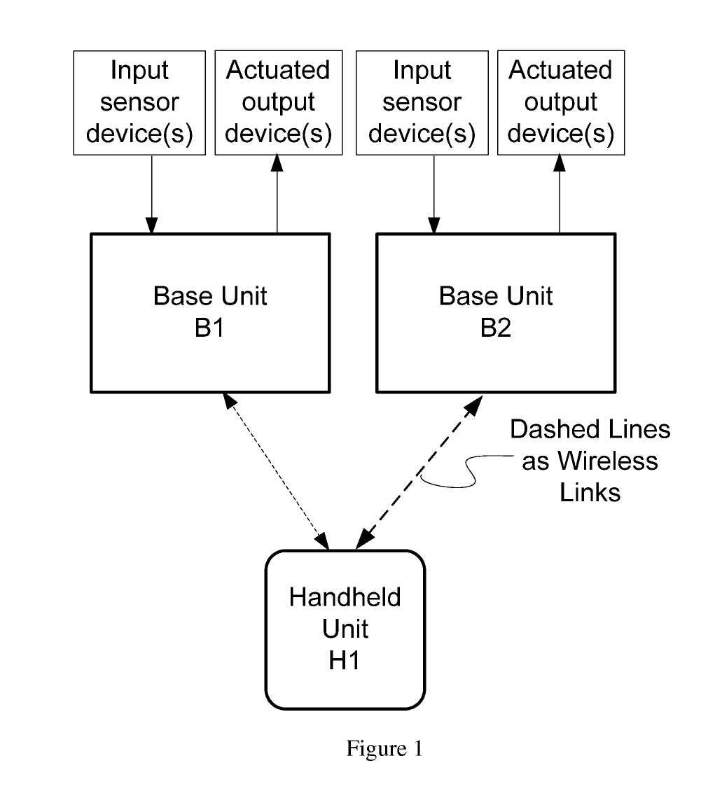

Schematic FIG. 1 illustrates, schematically, a first embodiment of a security system in accordance with the present invention. The security system comprises a number of module types. The module types include a first module type or a handheld device, e.g. H1. Handheld device H1 is relatively compact and the appearance resembles a car remote control device that is currently available on the market. In this embodiment, handheld device H1 has a total of six button-type keys, namely K1, K2, K3, K4, K5, K6, and one liquid crystal display. Handheld device H1 is configured to emit up to six different wireless signals. Depending on which of the keys is depressed a corresponding signal is emitted. The security system further comprises a second module type or a first secure entity. In this embodiment, the secure entity B1 is a conventional vehicle except in the present invention it is provided with a base unit with which handheld H1 can communicate. In other words, handheld device H1 serves as a key for access to both vehicles B1, B2.

In this embodiment, when vehicle B1 is first purchased, it is purchased with handheld device H1. Specifically, handheld device H1 and vehicle B1 are pre-registered with each other before they can be put into use. Details of the pre-registration will be explained in further detail later in the description. Once the pre-registration process has taken place, handheld device H1 is programmed and configured, on depressing the key K1, to emit a first wireless signal detectable by a receiver in the first vehicle B1. The first wireless signal includes codes encoding a first instruction for locking all doors of vehicle B1. The receiver of vehicle B1, on receiving the first wireless signal, reacts by sending a corresponding signal to relevant microprocessors in vehicle B1 to lock all the doors, in accordance with the first instruction. On completion of the locking of all the doors, a signal is transmitted to a wireless signal transmitter for transmitting a second wireless signal from vehicle B1 to handheld H1 for confirming the action of locking all the doors of the vehicle B1. Handheld device H1, on reception of the second wireless signal from vehicle B1, will display on the LCD display the status of the doors, i.e. the locked status of the doors. With this, when the user desiring to check whether the doors have been locked can simply look to the LCD display of the handheld device H1 for the status of the doors. This is to be contrasted with conventional systems in which after a user being away from the vehicle at a long distance and having forgotten whether s/he had in fact locked the doors or armed the vehicle would have no way of knowing the status of the vehicle. He would either have to return closer to the vehicle and lock or arm the vehicle again or have to live with being paranoid about whether the vehicle would be vulnerable to be tampered with. Details of the working of the codes will be explained in further detail later in the description.

In this embodiment, key K2 is designated for unlocking all the doors in vehicle B1. On depressing key K2, the third wireless signal is sent and then received by vehicle B1. On receiving the third wireless signal, a corresponding signal is sent to relevant microprocessors in vehicle B1 for unlocking the doors. Once the doors are unlocked, a fourth wireless signal is generated from vehicle B1. On receiving the fourth wireless signal, the display means of handheld device H1 will display the status of the doors of vehicle B1 as “unlocked”.

When the user of vehicle B1 subsequently purchases a second secure entity or vehicle B2, he has an option of acquiring a new handheld device with vehicle B2 pre-registered with a new handheld device. This is however undesirable because it would mean that the user would have to carry one more piece of hardware. Another more convenient option, as in this embodiment, would be to register vehicle B2 with his handheld device H1 so that the same handheld device H1 can control access to B2. Details of the pre-registration will be explained in further detail later in the description. After the pre-registration, keys K3 and K4 are designated for locking and unlocking of the doors of vehicle B2, respectively, in a similar fashion as keys K1 and K2 designated for the locking and unlocking of vehicle B1, respectively.

After the purchase of vehicle B2, there are still capacity left in handheld device H1 for subsequent changes in the future in case the user would like to change the designation of keys periodically for security reasons or for further expansion in case the user acquires a third vehicle. As can be understood from above, the user requires only one electronic key for access to two vehicles. Even when the user acquires a third vehicle in the future, still he can program the same handheld device to access to the third vehicle and there is no need to acquire a third piece of hardware for access thereto.

### Embodiment 2

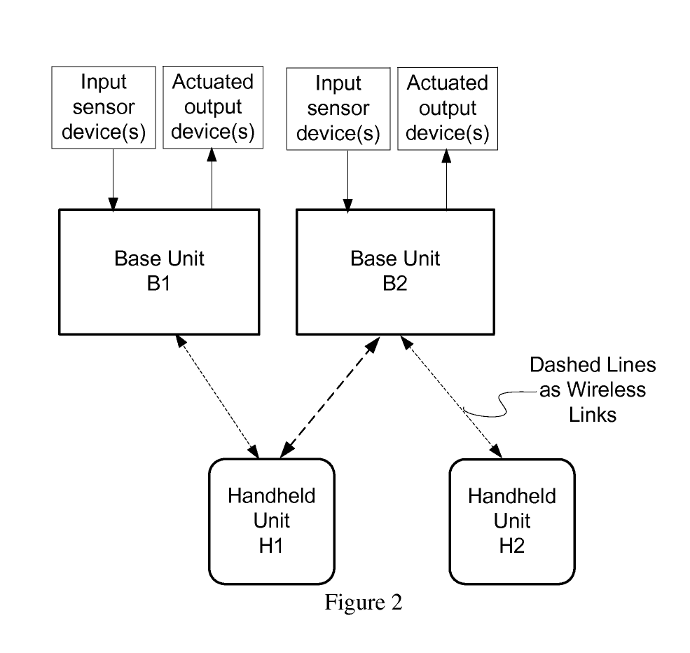

FIG. 2 is a schematic diagram illustrating a second embodiment of a security system in accordance with the present invention. The security system is generally similar to the security system of FIG. 1. One main difference is that there are two handheld devices H1, H2 involved, with one of the handheld devices H1 in possession at all times by a first user. In this embodiment, this first user has just married the second user, i.e. the spouse, who will require access to one of the two vehicles (i.e. vehicle B2) that the first user owns. To achieve this, handheld device H2 similar the handheld device H1 is purchased for the spouse. Before the second handheld device H2 and the second vehicle B2 can recognise each other, the second user will need to pre-register handheld device H2 and vehicle B2 to recognise each other. Details of the pre-registration will be explained in further detail later in the description. However, once the pre-registration process has taken place, handheld device H2 is programmed and configured, on depressing key K1, to emit a fifth wireless signal detectable by a receiver in vehicle B2. The fifth wireless signal includes codes encoding an instruction for locking all doors of vehicle B2. The receiver of vehicle B2, on receiving the wireless signal, reacts by sending a corresponding signal to relevant microprocessors in vehicle B2 to lock all the doors, in accordance with the instruction. On completion of the locking of all the doors, a signal is transmitted to a wireless signal transmitter for transmitting another wireless signal from vehicle B2 to handheld H2 for confirming the action of locking all the doors of vehicle B1. Handheld device H2, on reception of the second wireless signal from vehicle B2, will display on the LCD display the status of the doors, i.e. the locked status of the doors. With this, when the user desiring to check whether the doors have been locked can simply look to the LCD display of handheld device H2 for the status of the doors. This is to be contrasted with conventional systems in which after a user being away from the vehicle at a long distance and having forgotten whether s/he had in fact locked the doors or armed the vehicle would have no way of knowing the status of the vehicle. S/he would either have to return closer to the vehicle and lock or arm the vehicle again or have to live with being paranoid about whether the vehicle would be vulnerable to be tampered with. Details of the working of the codes will be explained in further detail later in the description.

The working of the above two embodiments is contributed by a first step of pre-registration and a second step of unique communication, to be explained as follows.

Pre-Registration of H1 and B1 with Each Other

When vehicle B1 and handheld device H1 are first purchased, they are considered as virgin and not readily able to emit signals for carrying instructions respondable by each other. Thus, they will need to undergo a pre-registration process in order to create a designated channel via which instructions from handheld device H1 intended for vehicle B1 and instructions from vehicle B1 intended for handheld device H1 are transmitted wirelessly in the designated channel.

1.) In this embodiment, the process is initiated by generating an identification for handheld device H1. The process is started by putting handheld device H1 into a programming mode. The identification is generated by the user manually selecting a code (or identification code) out of a pool of codes provided to handheld device H1. Each code is defined by a 16-digit binary code, and there are a total of 65536 codes (2 to the power of 16 or 2¹⁶). After selecting the identification code, it then becomes registered in handheld device H1 and the identification of handheld device H1. Any signal emitted from handheld device H1 will then carry this selected identification code.
2.) After the identification of handheld device H1 has been determined, a channel code with respect to vehicle B1 is to be selected so that signals carrying instructions for vehicle B1 generated by handheld device H1 will always carry this channel code. The identification code is stored in handheld device H1's non-volatile memory. This channel code is similar to the identification code as described above although the number of digits of the channel code is only five (5) in this embodiment. In other words, the channel code is selected out of a total of 32 (2 to the power of 5 or 2⁵). The number 32 also represents the maximum number of secure entities with which handheld device H1 can register. In an alternative embodiment, handheld device H1 may be configured such that a smaller pool of channel codes out the maximum available number of channel codes is available for selection by the user. The use of a smaller pool of channel codes allows the user to select more easily.
3.) After the channel code of handheld device H1 with respect to vehicle B1 has been determined, vehicle B1 is also put into a programming mode. Handheld device H1 is then caused to emit a signal carrying its identification code and the channel code with respect to vehicle B1 for reception by vehicle B1. On receiving this signal, vehicle B1 registers and saves this signal and will only respond to instructions from handheld device H1 only when the instructions are carried with this combination of identification code and channel code. This combination of identification code and channel code of handheld device H1 is stored in a non-volatile memory in vehicle B1.
4.) Once the combination of identification code and channel code from handheld device H1 has been stored in vehicle B1, vehicle B1 is then caused to select an identification code for itself, and also a channel code with respect to handheld device H1 only. Vehicle B1 is then caused to emit a signal carrying its identification code and the channel code with respect to handheld device H1. On receiving this signal, handheld device H1 registers and saves this signal and will only respond to instructions from vehicle B1 when the instructions are carried with this combination of identification code and channel code. This combination of identification code and channel code is stored in a non-volatile memory in handheld device H1.

Once the above steps have been completed, all signals emitted from handheld device H1 intended for vehicle B1 are respondable by vehicle B1 only and vice versa.

Pre-Registration of H1 and B2 with Each Other

When the user of handheld device H1 has subsequently acquired vehicle B2, he will need to similarly pre-register his existing handheld device H1 and new vehicle B2 with each other so that only signals emitted from handheld device H1 intended for vehicle B2 will be respondable by vehicle B2 and vice versa. Since an identification code has already been designated to handheld device H1, step 1.) is not needed. Otherwise, steps 2.) to 4.) are to be followed. However, when a channel code in handheld device H1 with respect to vehicle B2 is to be selected, a channel code different from that with respect to vehicle B1 is to be used. This is to ensure that signals from handheld device H1 intended for vehicle B1 will not be respondable by vehicle B2. The same applies to selecting a channel code in vehicle B1 with respect to handheld device H1.

Pre-Registration of H2 and B2 with Each Other

When the user of handheld H1 has married and would like to provide his spouse access to vehicle B2 only, they purchase a new virgin handheld device H2 which is similar to handheld device H1. In order to allow handheld device H2 and vehicle B2 to respond to instructions intended for each other, they will need to similarly pre-register new handheld device H2 and new vehicle B2 with each other based on the above principle and steps so that only signals emitted from handheld device H1 intended for vehicle B2 will be respondable by vehicle B2 and vice versa. Of course, when a channel code in vehicle B2 with respect to handheld device H2 is to be selected, a channel code different from that with respect to handheld device H1 is to be used. This is to ensure that signals from vehicle B2 intended for handheld device H2 will not be respondable by handheld device H1.

The above steps illustrate how a handheld device and a secure entity can register with each other and how to create a designated secure channel via which communication between the respective pair of handheld device and the secure entity can take place. It is however to be noted that the handheld device and the secure entity can be reprogrammed from time to time for security reason such that a different identification and/or a different channel is/are selected. It is also to be noted that a new designated secure channel can be created by using a combination of an old identification code and a new channel code, a new identification code and an old channel code or a new identification code and a new channel code for a pair of existing module and a new module.

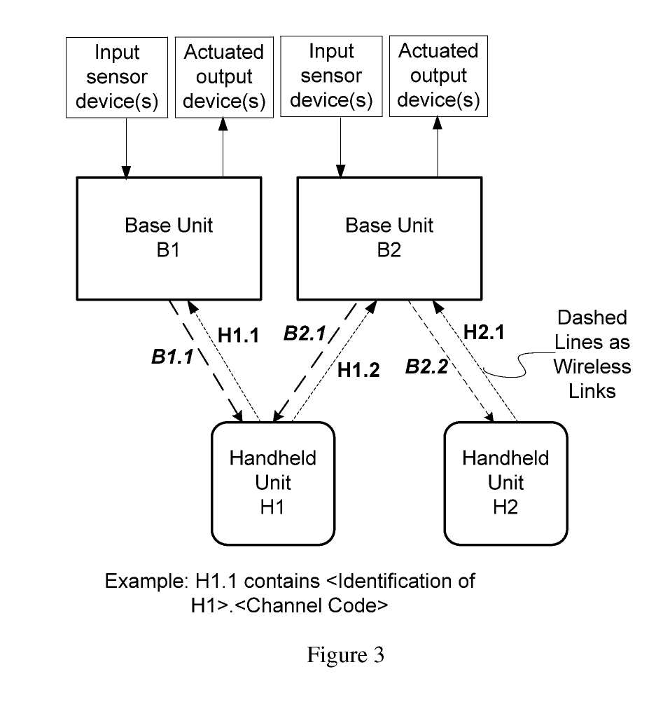

FIG. 3 is similar to FIG. 2 although it contains further details illustrating each designated or unique channel for each pair of handheld device-secure entity. For example, communication of instructions between handheld unit H1 and base unit of secure entity B1 is conducted exclusively via a channel of B1.1:H1.1. In this channel, signals from handheld H1 intended for vehicle B1 always carry the identification code of handheld device H1 and the channel code of “1” of H1. Vehicle B1 will not respond to any signal carrying whatever instructions unless the signal includes the codes for H1.1. Similarly, signals from vehicle B1 intended for handheld H1 always carry the identification code of vehicle H1 and the channel code of “1” of B1. Handheld device H1 will not respond to any signal carrying whatever instructions unless the signal includes the codes of B1.1. Communication between handheld device H1 and vehicle B2 is conducted exclusively in channel designated H1.2:B2.1 while communication between handheld device H2 and vehicle B2 is conducted exclusively in channel designated H2.1:B2.2 in a similar fashion.

### Near-unique and Unique Identification

In the embodiment of FIG. 2 and FIG. 3, since the pool of available identifications (i.e. 65,536) from which the user can select is relatively high, the possibility of accidental match, i.e. an independent user setting his own handheld device to an identification code identical to that of handheld device H1. Of course, in order to reduce the chance of accidental match, the number of binary digits used for defining an identification code should be increased although for many practical purposes the use of a 16 binary digit system should be sufficient. True uniqueness can only be achieved by having the odd be absolute zero, which requires the denominator to be infinitive, or infinite number of bits in the ID code, and obviously it is not possible in practice. It is to be understood that even in the unlikely scenario that another independent user has selected the same identification code, it does not automatically mean that vehicles B1 and B2 will respond to signals carrying this same identification code. This is because unless a channel code identical to the channel code (i.e. 1) selected by the user of handheld device H1 for vehicle B1 or B2 is also selected, vehicle B1 or B2 still would not respond to such signals. In other words, the chance that a module responding to a signal not intended thereto would be much less that 1/65536. As can be seen, the communication between each pair of handheld device and secure premises is a two-way unique communication via a pre-programmed designated channel In theory, absolute uniqueness cannot be achieved because the supposingly unique identification is merely near-unique. For practical purposes, unique means near-unique in this description. It is to be understood that there are numerous ways to represent identification besides this binary representation. Thus, the use of this particular binary representation should not be regarded as limiting to the scope of the present invention.

Unlike conventional identification systems, which are mainly for security and uniqueness purposes, the use of a combination an identification (code) and a channel code allows each pair of handheld device and secure entity to communicate with each other exclusively in a pre-defined channel. Even when more than one secure entity have registered with a handheld device (or vice versa) and a same identification code has been used, only the one that has pre-registered with a same channel code shall be able to respond. It is thus to be understood that, for example in Embodiment, the wireless signal from handheld device H1 intended for vehicle B1 is recognizable by the receiver in vehicle B1 and is respondable by vehicle B1 only.

This embodiment is to be compared with the conventional systems in which when two persons are to have access right, with one of the persons having access right to both vehicles and the other person having access right to only one of the vehicle, at least three separate keys would be needed. As can be understood from above, although there are two vehicles involved with one person having access right to both vehicles and the other person having access right to only one vehicle, only two keys or two handheld devices (i.e.) H1, H2 are required. It is envisaged that in a corporation in which there are many employees and many secure premises (e.g. rooms, computers, equipments, etc.), the number of handheld devices needed is also the same as the number of the employees. This is advantageous.

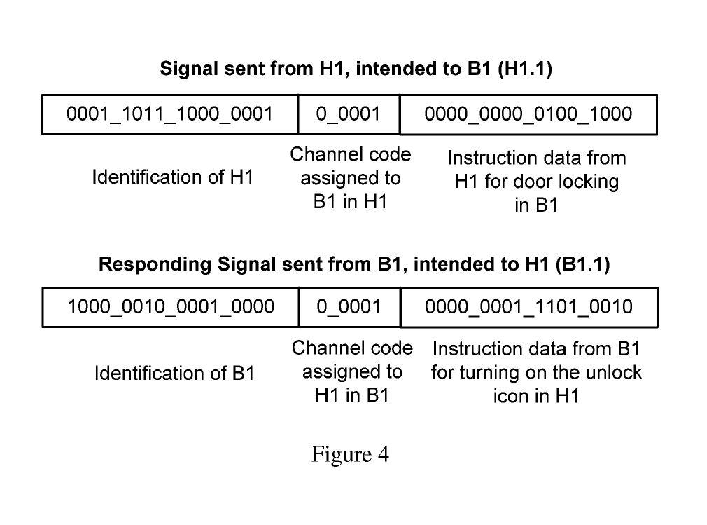

FIG. 4 illustrates an example of transmission of a signal from handheld device H1 intended for vehicle B1 and transmission of a feed back signal from vehicle B1 intended for handheld device H1. The signal sent from handheld device H1 intended for vehicle B1 is a code including three parts, namely a first part, a second part and a third part. The first part is actually the code identifying handheld device H1, the second part is actually the code identifying the channel set in handheld H1 with respect to vehicle B1, and the third part is a code carrying a desire instruction from handheld device H1 to vehicle B1. The feedback signal from vehicle B1 intended for handheld device H1 is a code also including three parts, namely a first part, a second part and a third part. The first part is actually the code identifying vehicle B1, the second part is actually the code identifying the channel set in vehicle B1 with respect to handheld device H1, and the third part is a code carrying a desire instruction from vehicle B1 to handheld device H1.

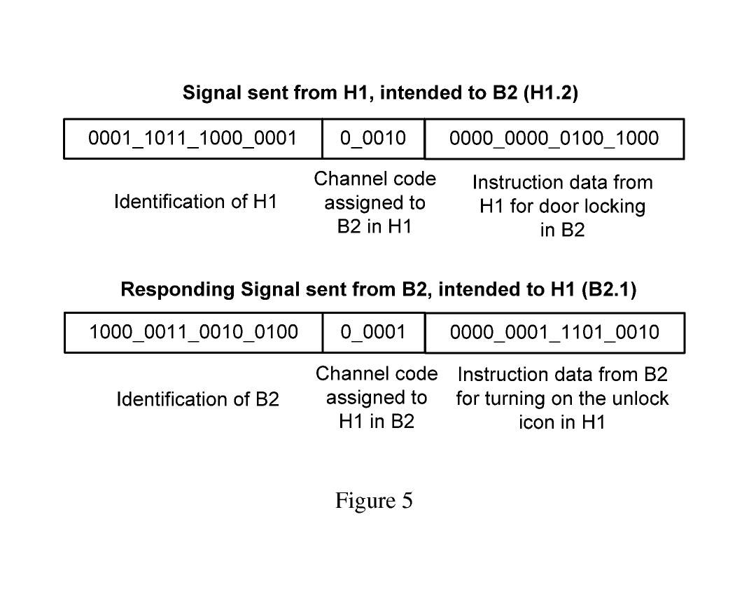

FIG. 5 is similar to FIG. 4, which illustrates an example of transmission of a signal from handheld device H1 intended for vehicle B2 and transmission of a feed back signal from vehicle B2 intended for handheld device H1. The signal sent from handheld device H1 intended for vehicle B2 is likewise a code including three parts, namely a first part, a second part and a third part. The first part is actually the code identifying handheld device H1, the second part is actually the code identifying the channel set in handheld H1 with respect to vehicle B2, and the third part is a code carrying a desire instruction from handheld device H1 to vehicle B2. The feedback signal from vehicle B2 intended for handheld device H1 is a code also including three parts, namely a first part, a second part and a third part. The first part is actually the code identifying vehicle B2, the second part is actually the code identifying the channel set in vehicle B2 with respect to handheld device H1, and the third part is a code carrying a desire instruction from vehicle B2 to handheld device H1.

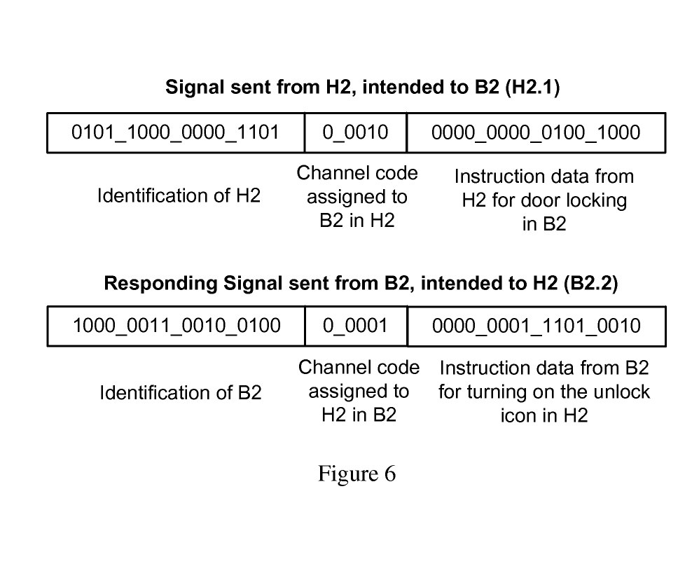

FIG. 6 is similar to FIG. 4 or 5, which illustrates an example of transmission of a signal from handheld device H2 intended for vehicle B2 and transmission of a feed back signal from vehicle B2 intended for handheld device H2. The signal sent from handheld device H2 intended for vehicle B2 is likewise a code including three parts, namely a first part, a second part and a third part. The first part is actually the code identifying handheld device H2, the second part is actually the code identifying the channel set in handheld H2 with respect to vehicle B2, and the third part is a code carrying a desire instruction from handheld device H2 to vehicle B2. The feedback signal from vehicle B2 intended for handheld device H2 is a code also including three parts, namely a first part, a second part and a third part. The first part is actually the code identifying vehicle B2, the second part is actually the code identifying the channel set in vehicle B2 with respect to handheld device H2, and the third part is a code carrying a desire instruction from vehicle B2 to handheld device H2.

Each module will only respond to signals from with specific combination of pre-programmed part 1 and part 2.

### Embodiment 3

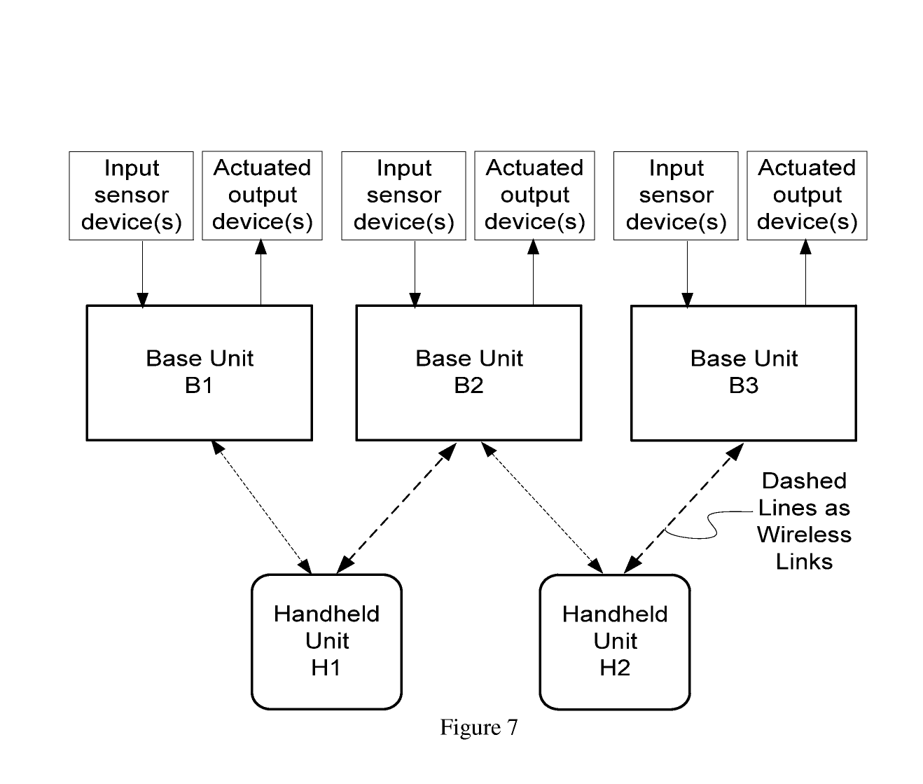

FIG. 7 is a schematic diagram illustrating a third embodiment of a security system in accordance with the present invention. This embodiment is similar to the system of FIG. 2 and FIG. 3 although there are a number of differences. First, instead of having two secure entities, there are three secure entities, namely a first vehicle B1, a residence B2 and a second vehicle B3. There are two persons to gain access although a first person, P1, has access right to B1 and B2 only, while a second person, P2, has access right to the secure entities B2 and B3 only. In other words, both the persons P1 and P2 have common access right to the residence B2 although each of them have access right to the respective vehicle B1 or B2. To gain access to the vehicle B1 and the residence B2, all that the person P1 requires is one handheld device H1. The pre-registration process of each pair of handheld device and secure entity is similar to that in Embodiment 2 and will not be repeated here.

The above embodiments are advantageous in that each user only requires one handheld device for controlling or gaining access to multiple secure entities. Specifically, regardless of the number of secure entities to be accessed, the number of device required for each user is always one.

In each of FIG. 1, FIGS. 2 and 3, and FIG. 7, the blocks labelled “input sensor device(s)” and the blocks labelled “actuated output devices” are connected to or reside in their respective modules. These blocks are expressed schematically to illustrate that they may as well be some common components existing in, for example, a typical vehicle. For instance, a car door serves merely a removable barrier between interior and exterior of a car. In the context of the present invention, it also serves as an input sensor device, which sends an instant signal signifying open/close events of the secure entity (the car) once they take place as such events are relevant to the secure entity for further processing and action. Furthermore, as a prevalent application, the car door also serves as an actuated output device that can be locked or unlocked by a signal sent from a security entity. For another instance, a car horn is typically only actuated by the driver's depressing on the inner portion of a steering wheel of a vehicle. However, in the context of the present invention, it can also be actuated by a signal sent from the handheld device.

### Handheld Device and Key System

In Embodiment 1, each key is designated for a specific function in a particular pre-registered secure entity. However, when the number of secure entities to be accessed is many, many keys would be needed on the handheld device and the handheld device would be crowded with the keys. The operation of such handheld device would be cumbersome.

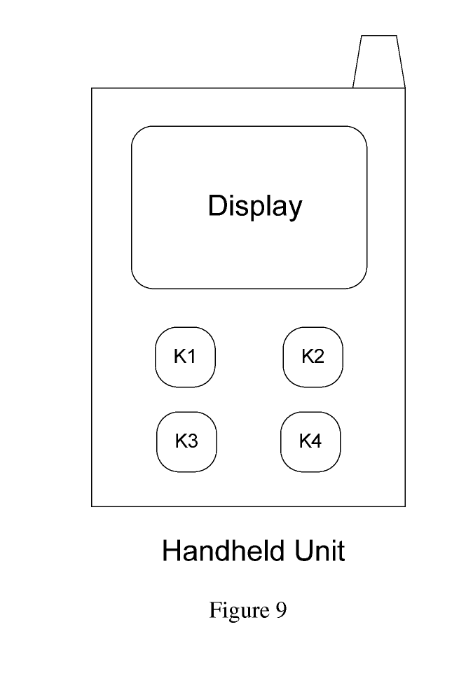

FIG. 9 is a schematic diagram showing an embodiment of a handheld device. In this embodiment, the handheld device has four keys, namely K1, K2, K3 and K3. The handheld device in FIG. 9 is different from that of handheld H1 in Embodiment 1 in that key K1 is for adjusting the channel (of the handheld device and with respect to which secure entity) via which the signal is about to be emitted. The LCD display will indicate the channel at which the handheld device is. Once the channel has been set, all signals emitted from the handheld device will not only carry the handheld device's identification code but also the channel code with respect to the selected secure entity. This means a user can select the secure entity to which he intends to send instructions via the handheld device by adjusting the channel by pressing key K1.

Once the channel has been set, the user may want to send an instruction to the secure entity for performing a certain action. This is achieved by pressing one of the corresponding key K2, K3 and K3 designated for pre-programmed functions. As can be understood, the same set of keys with predefined functionality in a handheld can be used for different secure entities or vehicles. If K2 and K3 are predefined as LOCKED, UNLOCKED for vehicle B1, they can also be used for LOCKED, UNLOCKED for vehicle B2 as long as the respective channel code has been selected by key K1. Thus, each secure entity or vehicle doesn't require its own set of keys on a particular handheld device. This will greatly reduce the number of keys required on the handheld device.

It is to be understood that there are many ways in which key system may be designed to allow a user to select channel and input instructions. The key systems described in this description are not intended to be limiting to the scope of the present invention.

### Other Embodiments

In another embodiment, and with reference to FIG. 9, the handheld device is provided with four push buttons K1, K2, K3 and K4, and this time with K4 being dedicated as a program/channel select button. K1, K2, K3 are dedicated as door LOCK, door UNLOCK, and NULL buttons for a first vehicle, the first secure entity, respectively; K1, K2, K3, can be door UNLOCK, door LOCK, and NULL buttons for an office door, the second secure entity, respectively; K1, K2, K3 can be password AUTHENTICATION, NULL, and NULL buttons for a PC, running a program that is requesting a password, the third secure entity, respectively. As can be seen, despite the handheld device can control access to three secure entities and manipulate the status of three functions, only four keys are used.

In another embodiment, there is an application in which once a new secure entity is acquired by a user, s/he depresses key K4 for longer than 5 seconds on the handheld (that s/he already has for his/her other existing secure entity(ies)) and also activates the new secure entity (for example by depressing a key of the secure entity corresponding to key K4 of the handheld device), in either sequence, to enter into the program mode. The user must do the programming procedure one pair at a time if there is more than one pair of modules to program. After the relevant pair of modules enter into the program mode, the user depresses and releases key K4 of the handheld device normally—that is, duration of depressing on the button is short than 5 seconds—one or more times until a desired unused channel is shown on the display of handheld. Then, s/he depresses K4 for longer than 5 seconds to start the unit registration process and to exit the program mode. During the registration process, the handheld sends out its identification and the channel selected; the secure entity receives and registers them, followed by returning its own identification together with an unused channel of its own back to the handheld. Once the secure entity returns the aforementioned data, it exits the program mode; likewise, once the handheld receives and registers the returned data from secure entity, it exits the program mode as well, thereby completing the programming procedure.

In alternative embodiments, commands from the handheld unit(s) are issued through keypad, physical or virtual touch-screen, and such commands are received, interpreted, and processed at the secure entity. As each secure entity can respond to one or more registered handheld units, the secure entity is adapted and configured to keep states and status of each of such individual handheld units, and acts correspondingly. Status can be displayed on a screen, such as LCD panel on the handheld device as described above, or a simple set of lighting devices, such as a group of LEDs at the handheld device. It is to be understood that it is the secure unit instructing the handheld device what to display according to status information administrated within the secure entity. The handheld device may therefore be considered a “dummy” primitive unit merely responsible for transmitting a stream of (channel) code representing certain depressed keys and receiving another stream of code containing exact message to display.

Various radio frequency (RF) technologies may be used for wireless implementation for links between handheld device and secure entities in accordance with the present invention. Studies have shown that, preferably, frequency of operation is one that does not require specific license pertaining to Title 47 of Code of Federal Regulations from Federal Communication Commission for the United States, such as one in the range of 260-470 MHz, or 902-928 MHz, as long as data type, signal strength, and signaling duty cycle are observed according to the regulations.

Input/output circuitry for wireless transceiving (transmitting and receiving), modem (modulation and demodulation) and codec (encoding and decoding) capabilities are the basic building blocks realizing both handheld devices and base units of the secure entities. For example, transcoder under MT series from LINX Technologies may be used. Reference is made to the product specification published in April 2008 for MT series transcoder Part # LICAL-TRC-MT and for MT Master Development System Part # MDEV-LICAL-MT, content of which is incorporated here in its entirety. These building blocks for handheld device can be integrated in existing devices, such as utilizing screens and keys readily provided in cellular phone, Pocket PC/PDA (Personal Data Assistant), watch or picture frame integrated key chain ornament, embodiments of which will be elaborated as follows.

As it is understood from the above explained embodiments, one implementation of such a security system is for the car remote keyless entry system. It is envisaged that a user can verify the status of his car as to whether the doors are locked or not, or the security system is activated or not, by way of a visual inspection of his/her handheld device. Alternatively, the handheld device is configured to emit an audible signal reflecting the status. This is to be contrasted with conventional systems in which the user must have the ability to listen from afar or to see the car in line of sight if he/she wishes to do verification having walked away from the car at a distance such as a few tens of feet and beyond.

It is envisaged that in alternative embodiments in accordance with the present invention, the security system can be configured to emit a wireless signal detectable by the associated handheld device(s) and as such the car owner can be immediately notified of theft or tampering. In such embodiments, the output device of the vehicle will send a wireless distress signal to the handheld device(s) with which the vehicle has registered, allowing the owner to take appropriate action in a timely manner.

It is also envisaged that in alternative embodiments in accordance with the present invention, a new secure entity, e.g. a car, residence or a computer, can be purchased without a key. Such embodiments will be similar to the second embodiment or the third embodiment as illustrated in FIGS. 1 and 2. In particular, when having acquired a new secure entity, the user or each of the users will still not require a further handheld device and can use the (or their) existing handheld devices. The (or each) of the handheld devices has a near-unique identification and a channel code of 20 possibilities. A programming procedure is needed to establish the unique relationship among the secure entity and the handheld unit(s). After the new secure entity has been acquired without a new key, the owner or each owner will select a channel out of remaining unused nineteen unassigned channels before broadcasting its near-unique identification and channel code. Since it is only the new secure entity which is in the proximity at the time the programming mode is set in this time frame, the new secure entity is the only module respondable or responding to the broadcast from the handheld device. As part of the programming procedure, the new secure entity registers the identification and channel code it receives from the existing handheld device, and in return, the new secured device broadcasts its own identification along with an unused channel. Since the existing handheld device and the new secure entity are still the only ones in the proximity set in programming mode, the existing handheld is the only other unit responding to the broadcast from the new secure entity, registers the identification and channel code sent from the new secure entity. This completes the programming procedure.

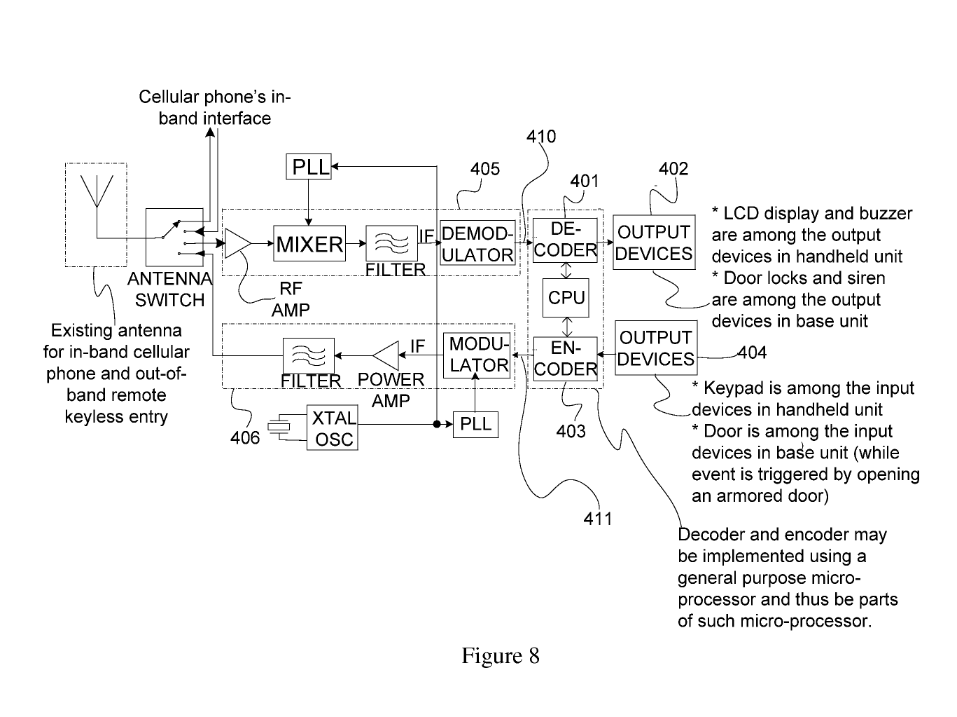

In alternative embodiments, the security system may be realized by integrating additional RF circuitry and software into existing devices and thus avoid creating another piece of hardware to carry by the user for the new benefit. Usefulness of a cellular phone (or a digital wristwatch) may be augmented with the function of the handheld device as illustrated above. LCD display, keypad or individual push buttons, micro-controller or processor, or antenna, etc. are readily available building blocks sharable by the requirements in the present invention. An implementation for the handheld device or the base unit of the secure entity is illustrated in FIG. 8. An antenna switch, local oscillator and mixer for intermediate frequency generation in a super-heterodyne receiver, demodulation and modulation for amplitude On-Off-Keying, and amplifiers and filters at appropriate stages to condition signal amplitude and frequency compose the additional RF circuitry. The circuitry can be realized in an integrated monolithic semiconductor device. Data decoding, error detection for noise immunity and encoding functions are performed in a micro-controller or processor with respective enhanced software.

It is envisaged that for practical and aesthetic advantages, the handheld unit devices are configured to be as physically small as possible. As explained above, most if not all data and signal processing is performed in the secure entity. It is to be understood that in most cases most required hardware of the security system in accordance with the present invention resides in the secure entity which may be at a fixed location or at least typically provide relatively more physical space for accommodating the hardware than that of the handheld device otherwise allows. The handheld device sends out a simple signal representing a depressed key as user command, the secure entity that has registered with the handheld device receives, decodes and responds to the signal, such as locking the doors and armoring the security system. Upon intended actions for the command is completed, status of this particular user is updated in the secure entity (e.g. vehicle). Some encoded signals specific to a type of LCD panel and/or an audible buzzer are then sent out from the car as feedback. The handheld device that has registered the car receives and decodes the signals, causing relevant status message to display on its LCD and a distinct tone to sound from its buzzer.

It is to be understood that an operation command or request is originated by the user from the handheld device. Such command or request is received remotely by the counterpart secure entity. The secure entity processes the request and automatically sends a status signal back to the handheld device. This signal considered as a feedback signal is received by the handheld device, actuates an on-board display and/or an audible device to represent pertinent information conveyed by the feedback signal.

It is envisaged that the present invention provides a universal platform and is suitable for use in various applications, which benefit the user with a universal handheld device for secured remote access of multiple domains of secure entities. Such domains can be of various types and purposes.

One such domain is for strengthening security in computing. Presently, identification is verified and thus authorization is granted as long as the correct password is entered regardless of the legitimacy of the person entering the password. As each password is merely a piece of information, anyone learns of it as knowledge can use it at will and the possession of the password does not translate to the person necessarily being the legitimate user. Further embodiments in accordance with the present invention add a physical means linked to the legitimate user in the authorization process. It is envisaged that in addition to a valid password, a secure entity which in these embodiments taking the form of a personal computer in the authorization granting computer, implemented in a USB-based dongle device for example, must receive a valid identification from a handheld unit to complete the authorization process, as such greatly reducing possibility of impersonated entry.

Another domain is for room entry, one of the most conventional uses of key. It is envisaged that a handheld device in accordance with the present invention can enter multiple rooms, each room representing a secure entity registered with the handheld device, using a single physical key.

As can be understood, in a further embodiment of a security system in accordance with the present invention, a user can program his/her one handheld device to have Channel 1 for access to vehicle A, Channel 2 for access to room A, Channel 3 to vehicle B, Channel 4 to computer A, Channel 5 to room B, and so on.

In an alternative embodiment, as shown in FIG. 8, a cellular phone manufacturer can have cellular phones manufactured with such built-in handheld devices configured to establish, for example, twenty channels for near-unique communication with secure devices such as vehicles, residence, etc. The advantages with incorporating the present invention in cellular phone context is that most people nowadays have a cellular phone and existing cellular phone already possesses components including one of more displays, command keys and antennas which are likewise usable and sharable by the emit and receive desire near-unique signals for communication with secure entities. As such, a cellular phone manufacturer can easily modify the design and adapt it to also function as a security device. As an added feature, the cellular phone can provided with password-protected access and an unauthorized user of the cellular phone will not be able to operate it or to gain access to the secure entities registered with the cellular phone unless a legitimate password is entered thereat.

A further embodiment is similar to that illustrated in FIG. 8. Components to the left of Interface 410 and 411 are in the analogy domain whereas components to the right of the interfaces are in the digital domain. It is to be understood that this further embodiment is concerned with an implementation suitable for the handheld device or the base unit of the secure entity. The following example illustrates how this embodiment in accordance with the present invention works. In this embodiment, the secure entity is a vehicle and the owner of the vehicle intends to arm his car. Upon the owner depresses a button in his remote key fob, a signal is sent from the button (block 404 in key fob in FIG. 8) to an encoder. An encoded digital code containing command of the user's request is then sent from the encoder to a modulator over Interface 411. The modulator provides the signalling suitable for wireless transmission in a radio frequency (RF) band. RF signal is transmitted from the key fob and received by base unit of a secure entity (e.g. a car). The super-heterodyne receiver in the secure entity converts the incoming RF signal to a fixed intermediate frequency (IF) suitable for detection in later stages of processing by mixing the RF signal with a frequency generated by a local oscillator. The IF signal is demodulated to binary digital signalling, which is further sent to a decoder over Interface 401. A central processing unit (CPU) sees the security arming desire originated from the user and thus locks the doors in block 402 of the car and/or activates the car security system also in block 402 of the car. The secure entity subsequently sends a signal back to the user's remote key fob to notify him that the operation was successfully performed. This feedback signal from car to key fob is processed in a similar fashion as the signal originated from key fob to car. It is encoded and sent to the modulator in the secure entity through its Interface 411. The modulated signal is then sent in RF signalling from the secure entity and received by the key fob. Once it is received by the key fob, the signal is converted to an IF signal for demodulation in the key fob. The demodulated digital signal is then decoded into commands and data necessary to display relevant visual information in block 402 of the key fob and/or to excite relevant audible device also in block 402 of the key fob.

In one embodiment, a given handheld device is suitable for use with multiple secure entities. Definition of keys is as interpreted by each secure entity. Content in the instruction data, as shown in FIGS. 4, 5, and 6, caused by each key is the same regardless of the intended receiving secure entity. It is secure entity's responsibility to correctly interpret the instruction data and take corresponding action; it is the user's responsibility to know which key or combination of keys to use in order for the secure entity to act according to the user's desire. One car, a secure entity, may interrupt K1, as shown in FIG. 9, as the instruction to open all doors; however, a second car may interrupt the same K1 as the instruction to close all doors. A different user manual comes with each secure entity; definition of keys is specified in it for the user to know how each respective secure entity interprets the set of keys. On the other hand, content in the instruction data sent from the secure entity can be universally interrupted by all handhelds as a common protocol, such as an acknowledge signal to cause a ACK icon on a LCD display to lit or a string of ASCII codes to show text on the LCD display for conveying a more elaborated message.

It is envisaged that when the security armed vehicle car is tampered with an attempted break-in and upon a motion sensor in one of the doors in block 404 has detected the attempted break-in, a signal is sent from the door (block 404 in car) to an encoder. An encoded digital code containing command of the distress sign is then sent in two routes: (1) from the encoder to a modulator over Interface 411 for wireless transmission to the remote key fob; and (2) from the encoder to a CPU for event administration. In the route to the modulator, the modulator provides the signalling suitable for wireless transmission in a radio frequency (RF) band. RF signal is transmitted from the car and received by the remote key fob held by the user. The super-heterodyne receiver in the key fob converts the incoming RF signal to a fixed intermediate frequency (IF) suitable for detection in later stages of processing by mixing the RF signal with a frequency generated by a local oscillator. The IF signal is demodulated to binary digital signalling, which is further sent to a decoder over Interface 401. A central processing unit (CPU) sees the distress signal originated from the car and thus excites a buzzer and/or displays an alert signal in block 402 of the key fob. In the route to the CPU, the distress signal is logged in the CPU as an event, decoded and then forwarded to excite a siren as an audible warning signal in block 402 of the car and/or to blink the car headlights as a visual warning signal also in block 402 of the car.

It should be understood that certain features of the invention, which are, for clarity, described in the context of separate embodiments, may be provided in combination in single embodiments. Conversely, various features of the invention which are, for brevity, described in the context of a single embodiment, may also be provided separately or in any appropriate sub-combinations.

1. A security system, comprising:
(a) a first handheld device configured to emit a first wireless signal encoding a first instruction; and
(b) a first secure entity configured to receive the first wireless signal, and on receiving the first wireless signal carry out the first instruction to perform a first predetermined action corresponding to the first instruction and then send out a second wireless signal corresponding to the first predetermined action providing an indication of the performance of the first predetermined action via the first handheld device,
wherein said first predetermined action is selected from a group including:
(i) locking or unlocking the first secure entity,
(ii) arming or disarming the first secure entity;
(ii) allowing or disallowing access to the first secure entity;
(iii) activating or deactivating the first secure entity; or
(iv) checking locked/unlocked status of the first secure entity;
wherein the first wireless signal is irrespondable by secure entities not having previously registered with the first handheld device; and
wherein the second wireless signal is irrespondable by handheld devices not having previously registered with the first secure entity.

2. A security system as claimed in claim 1, wherein said first handheld device is configured to emit a third wireless signal encoding a second instruction for reception by the first secure entity, wherein the first secure entity is configured to, on receiving the third wireless signal, carry out the second instruction to perform a second predetermined action corresponding to the second instruction and send out a fourth wireless signal corresponding to the second predetermined action providing an indication of the performance of the second predetermined action via the first handheld device, wherein the second predetermined action is different from the first predetermined action and is selected from a group including:
(i) locking or unlocking the first secure entity,
(ii) arming or disarming the first secure entity;
(v) allowing or disallowing access to the first secure entity;
(vi) activating or deactivating the first secure entity; or
(vii) checking locked/unlocked status of the first secure entity.

3. A security system as claimed in claim 1, comprising a second secure entity with which the first handheld device previously registered each other, wherein the first handheld device is configured to emit a fifth wireless signal encoding a third instruction for reception by the second secure entity, wherein the second secure entity, is configured to, on receiving the fifth wireless signal, carry out the third instruction to perform a third predetermined action corresponding to the third instruction and send out a sixth wireless signal to the second secure entity corresponding to the third predetermined action providing an indication of the performance of the second predetermined action via the second secure entity, wherein said third predetermined action is selected from a group including:
(i) locking or unlocking the second secure entity;
(ii) arming or disarming the second secure entity;
(iii) allowing or disallowing access to the second secure entity;
(iv) activating or deactivating the second secure entity; or
(v) checking locked/unlocked status of the first secure entity.

4. A security system as claimed in claim 1, comprising a second handheld device with which the first secure entity previously registered each other, wherein the second handheld device is configured to emit a seventh wireless signal for reception by the first secure entity, wherein the first secure entity is configured to, on receiving the seventh wireless signal, carry out a fourth instruction to perform a fourth predetermined action corresponding to the fourth instruction and send out an eighth wireless signal to the first secure entity corresponding to the fourth predetermined action providing an indication of the performance of the fourth predetermined action via the second handheld device, wherein the fourth predetermined action is selected from a group including:
(i) locking or unlocking the first secure entity;
(ii) arming or disarming the first secure entity;
(iii) allowing or disallowing access to the first secure entity;
(iv) activating or deactivating the first secure entity; or
(v) checking locked/unlocked status of the first secure entity.

5. A security system as claimed in claim 3, comprising a second handheld device with which the second secure entity previously registered, the second handheld device is configured to emit a ninth wireless signal for reception by the second secure entity, wherein the second secure entity is configured to, on receiving the ninth wireless signal, carry out a fifth instruction to perform a fifth predetermined action corresponding to the fifth instruction and send out a tenth wireless signal to the second secure entity corresponding to the fifth predetermined action providing an indication of the performance of the fifth predetermined action via the second handheld device, wherein the fifth predetermined action is selected from a group including:
(i) locking or unlocking the second secure entity;
(ii) arming or disarming the second secure entity;
(iii) allowing or disallowing access to the second secure entity;
(iv) activating or deactivating the second secure entity; or
(v) checking locked/unlocked status of the second secure entity.

6. A security system as claimed in claim 1, wherein the handheld device is a car key, a car alarm remote control or a cellular phone.

7. A security system as claimed in claim 1, wherein the wireless signals are of radio frequency signals.

8. A security system as claimed in claim 1, wherein the handheld device comprises means for a user to input command for emitting the wireless signal.

9. A security system as claimed in claim 8, wherein the input means is one or more physical and/or virtual touch-screen keys or buttons.

10. A security system as claimed in claim 1, wherein the handheld device comprises means for displaying the indication to a user.

11. A security system as claimed in claim 1, wherein one or more further secure device(s) is/are registrable with the first handheld device and/or one or more further handheld devices is/are registrable with the first secure entity, for communicating therewith one or more further predetermined action(s).

12. A security system as claimed in claim 1, wherein the secure entity is configured to emit a further wireless signal when a predetermined status is detected by the secure entity, wherein the security system is configured such that only the first handheld device is respondable to the further wireless signal, leading to a corresponding indication on the first handheld device.

13. A security system comprising:
(a) at least a first handheld device, a first secure entity and a second secure entity, wherein the first handheld device and the first secure entity are programmable to enter into a first unique communication mode in which only the pair of the first handheld device and the first secure can respond to each other's instructions and wherein the first handheld device and the second secure entity are programmable to enter into a second unique communication mode in which only the pair of the first handheld device and the second secure entity can respond to each other's instructions; or
(b) at least a first handheld device, a second handheld device and a first secure entity, wherein the first handheld device and the first secure entity are programmable to enter into a first unique communication mode in which only the pair of the first handheld device and the first secure can respond to each other's instructions and wherein the second handheld device and the first secure entity are programmable to enter into a second unique communication mode in which only the pair of the second handheld device and the first secure entity can respond to each other's instructions.

14. A handheld device in a security system, comprising:
(a) means for allowing the handheld device be registrable with a first secure entity;
(b) means for emitting a first wireless signal encoding a first instruction for response by only the first secure entity instructing the first secure entity to perform a first predetermined action;
(c) means for receiving a second wireless signal emitted from the first secure entity providing a first indication of the performance of the first predetermined action or reporting status of condition of the first secure entity;
(d) means for displaying the first indication on the handheld device;
(e) means for allowing the handheld device be registrable with a second secure entity;
(f) means for emitting a third wireless signal encoding a second instruction for reception by the second secure entity instructing the second secure entity to perform a second predetermined action;
(g) means for receiving a fourth wireless signal emitted from the second secure entity providing a second indication of the performance of the second predetermined action or reporting status of condition of the second secure entity; and
(h) means for displaying the second indication on the first handheld device;
wherein the signals are configured to be irrespondable by secure entities not previously registered with the first handheld.

15. A secure entity, comprising:
(a) means for allowing the security entity be registrable with a first handheld device;
(b) means for receiving a first wireless signal encoding a first instruction from the first handheld device;
(c) means for performing a first predetermined action corresponding to the first instruction;
(d) means for emitting a second wireless signal respondable by only the first handheld device providing an indication of the performance of the first predetermined action or reporting status of condition of the secure entity;
(e) means for allowing the secure entity and a second handheld device be registrable with each other,
(f) means for receiving a third wireless signal encoding a second instruction from the second handheld device;
(g) means for performing a second predetermined action corresponding to the second instruction; and
(h) means for emitting a fourth wireless signal respondable by the second handheld device providing an indication of the performance of the second predetermined action or reporting status of condition of the secure entity.

16. A secure entity as claimed claim 15, wherein the secure entity is a vehicle, a premises or a computer.

17. A secure entity as claimed in claim 15, configured to emit a fifth wireless signal when a predetermined status is detected thereby, wherein the fifth wireless signal is respondable by the first and/or second handheld device, leading to an indication on the first and/or second handheld device(s) and advising user of the first and/or second handheld device(s) of the predetermined status.
